(19) United States
(12) Patent Application Publication
(10) Pub. No.: US 2003/0014577 A1
(43) Pub. Date: Jan. 16, 2003

(54) USB wireless keyboard protocol

(76) Inventors: Shyh Ren Kuo, Taipei (TW); Tzong-Yu Wang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/901,715

(22) Filed: Jul. 11, 2001

(51) Int. Cl. G06F 13/12

(52) U.S. Cl. 710/64

(57) ABSTRACT

A USB wireless keyboard protocol, applied to a computer system using a wireless keyboard. When the USB has entered a standby status, and when the keyboard key is pressed to activate the system from a distant end, to save power consumption and satisfy the regulation of USB standby mode, the receiver will supply power in a specific period of time to the RF module (or I.R.LED) to receive the identification codes transmitted by the keyboard. To reduce reception time, it has additional shorter dummy codes during normal transmission of identification codes, to shorten the time for identification, saving power consumption at USB standby mode.

### BACKGROUND OF THE INVENTION

1. Field of the Invention

This invention relates to a USB wireless keyboard protocol, that is capable of signal identification and remote control wake-up operation between the USB wireless keyboard and a computer main unit, in a rapid and effective way to reduce the time required by the receiver and the transmitter to identify the identification codes, and save power consumption when the USB is at standby mode.

2. Background of the Invention

Conventionally, a proper transmission interface is required between a conventional computer unit and a peripheral appliance, with a signal cable connecting them for signal conversion and data transmission. In recent years, a computer product of USB communication interface has been introduced, to enable a wireless signal transmitter and receiver to receive control signals transmitted from all kinds of wireless peripherals through USB signal transmitter, so that all USB peripherals can control and operate the computer by wireless transmission.

In the application of USB wireless keyboard, since the USB keyboard and PS2 keyboard are conspicuously different in their operational features, a wireless transmission protocol must be designed to suit such features to comply with relevant specifications. In repetition identification codes during keyboard operation, in particular, when a number of keys have been pressed, the USB keyboard transmit signals repeatedly from each key that is pressed individually, while a PS2 keyboard transmit signals repeatedly on the final key that has been pressed. Besides, in remote control wake-up function, with a USB keyboard, when the key interruption code disappears, the identification code in the buffer must be cleared, or it will result in an illusion that the key has been pressed repeatedly. Since the keyboard requires a specific time period to repeat the transmission of identification codes, it would easily result in repeated operation of the transmitter module, causing waste of electrical energy. When the system has entered a standby status, this phenomenon will even influence the normal operation of remote wake-up performance.

### SUMMARY OF THE INVENTION

The invention provides a USB wireless keyboard transmission protocol, for exclusive application to wireless signal transmission between a computer main unit and a USB wireless keyboard, for effective solution to the problem of error and system fault that may be caused by aforementioned repeated identification codes.

The primary objective of this invention is to provide a USB wireless keyboard protocol, which is capable of signal identification and remote control wake-up operation between the USB wireless keyboard and a computer main unit. It can rapidly and effectively reduce the time required by the receiver and the transmitter to identify the identification codes and save power consumption when the USB is at standby mode.

### DETAILED DESCRIPTION OF THE INVENTION

According to the invention, the USB wireless keyboard protocol includes some shorter dummy codes in the keyboard within a normal time period for transmission of identification codes in order to reduce the time required for identification and save power consumption at USB standby mode.

When the USB has entered into a standby mode, the key must be pressed before remote control activated to execute wake-up function. To save power consumption and satisfy the requirement for reduced consumption of power at standby mode, the receiver shall supply power to RF module within a specified period of time, and to receive the identification codes transmitted by the keyboard. With the protocol of the invention, the keyboard includes some additional and shorter dummy codes during the time interval for normal transmission of identification codes, so that the time for identification can be reduced while the receiver does not have to supply power continuously. Therefore, power consumption can be reduced, system stability can be ensured, and anticipated objectives can be achieved.

The USB wireless keyboard protocol of the invention is applied to wireless peripherals, particularly to computer systems using USB wireless keyboards.

This invention involves a signal transmission module on the keyboard. During the period when the keyboard in the process of normal transmission of identification codes, there are additional, shorter dummy codes, so that the receiver can continuously repeat the reception of identification signals, without clearing the data buffer, but will not result in error during the identification process.

When the receiver continues to receive such dummy code, it indicates that the USB keyboard and the RF module (or I.R.LED) of the receiver are at normal working conditions, therefore, there is no need of power supply to the RF module. Therefore, it will reduce the time required for identification and significantly upgrade efficiency.

This invention provides the USB with rapid identification signals without interference, saving power energy when the USB is at standby mode, so that the receiver and the transmitter can have excellent transmission quality.

As mentioned above, the USB wireless keyboard protocol of the invention involves the adoption of a keyboard signal transmitter, which continuously transmits shorter dummy codes during normal reception of identification codes, to inform the signal receiver to ensure normal USB operation. It will not only reduce the time for signal identification, but will also upgrade the stability of USB signal transmission.

What is claimed is:

1. A USB wireless keyboard protocol applied to a computer system using a wireless keyboard, comprising shorter dummy codes during normal transmission of identification codes in order to shorten the time for identification; when the USB has entered a standby status, and when the keyboard key is pressed to activate the remote control wake-up system, the shorter dummy codes reduces the required time for identification, saves power consumption and satisfies the regulation of USB standby mode.
